(19) United States
(12) Patent Application Publication
(10) Pub. No.: US 2025/0383367 A1
(43) Pub. Date: Dec. 18, 2025

(54) WEEPING AIRSPEED SENSOR FOR SMALL UNMANNED AERIAL SYSTEMS

(71) Applicant: Georgia Tech Research Corporation, Atlanta, GA (US)

(72) Inventors: Kevin Lee Kamperman, II, Atlanta, GA (US); Mark W. Pettey, Atlanta, GA (US); Jesus Arias, Atlanta, GA (US)

(21) Appl. No.: 19/238,188

(22) Filed: Jun. 13, 2025

Related U.S. Application Data
(60) Provisional application No. 63/660,430, filed on Jun. 14, 2024.

(51) Int. Cl. G01P 5/14; G01P 1/00

(52) U.S. Cl. CPC G01P 5/14; G01P 1/00

(57) ABSTRACT

An airspeed instrument that employs one or more circulation chambers to receive and circulate incoming airflow to separate moisture from the air that can be then expelled via a drainage port. The exemplary airspeed instrument apparatus can be implemented as a small instrument appropriately sized for small UASs and aircraft. The separation chamber has an angled bottom surface that leads to a sampling port positioned at the top of the chamber, which prevents moisture from entering the sampling port into the measuring electronics. In some embodiments, the exemplary airspeed instrument apparatus is configured with an integrated static port sensor.

### RELATED APPLICATION

This U.S. application claims priority to, and the benefit of, U.S. Provisional Patent Application No. 63/660,430, filed Jun. 14, 2024, entitled “WEEPING AIRSPEED SENSOR FOR SMALL UNMANNED AERIAL SYSTEMS,” which is incorporated by reference herein in its entirety.

### BACKGROUND

Airspeed is an important measurement for flight. Commercial and large aircraft, and large drones (e.g., small to large fixed-wing), are typically equipped with a Pitot tube instrument configured to measure the total pressure of air during flight. Pitot tubes are often placed at the front of an aircraft or the wing to measure the airstream flowing from the direction of travel of the aircraft. Typically for small UAS both total and static ports are in one combined Pitot-static tube. In manned vehicles they are usually separated where second Pitot-static tube detects the static pressure in addition to the total pressure. According to Bernoulli's principle, total pressure is the sum of static pressure and dynamic pressure. Dynamic pressure, as a measure of airspeed, can then be determined as the difference between the two measurements. Pitot tubes on an aircraft tend to freeze at higher altitudes due to moisture blockage and lower temperatures. Pitot tubes are often equipped with heating elements to avoid freezing and clogging.

Small-scale Unmanned Aerial Vehicle (sUAV) also employs instruments for airspeed. Existing airspeed sensors for sUAV are often not equipped with heating elements and can clogged due to freezing and/or precipitation. A clogged airspeed sensor may reduce the flight autonomy and the safety of the pilots.

There is a benefit to improving the design of the airspeed sensor.

### SUMMARY

An exemplary airspeed instrument apparatus and method are disclosed that improve the Pitot tubes for total pressure measurement by employing one or more circulation chambers to receive and circulate incoming airflow to separate moisture from the air that can be then expelled via a drainage port. The exemplary airspeed instrument apparatus can be implemented as a small instrument appropriately sized for small UAVs and aircraft. The separation chamber has an angled bottom surface that leads to a sampling port positioned at the top of the chamber, which prevents moisture from entering the sampling port into the measuring electronics. In some embodiments, the exemplary airspeed instrument apparatus is configured with an integrated static port sensor. The exemplary airspeed instrument apparatus may alternatively operate with a second sensor for static pressure measurement. In a first embodiment, the static port sensor has a sampling tube that is co-located with the total pressure (TP) sampling tube, having a concentric port that accesses a portion of the total pressure sampling tube. In a second embodiment, the static port sensor has a sampling tube that extends out of the sensor in a different direction to the total pressure sampling tube. The exemplary airspeed instrument apparatus and method may be fabricated as a sensor component that is mounted/attached to the small UAVs and aircraft. In another embodiment, the exemplary airspeed instrument apparatus and method may be formed in the small UAVs and aircraft chassis itself.

The exemplary airspeed instrument apparatus and method can separate moisture and liquid from the incoming airflows without the need for heating and other conventional means to avoid moisture accumulation within the sensor housings or probes. The exemplary airspeed instrument apparatus and method can be implemented in a small factor to provide dehumidified total pressure measurement. A similar separation operation may be implemented for static pressure measurement. Integration of both total pressure and static pressure measurements in an small integrated sensor also reduces the footprint and weight for the sensor, important feature for small UAVs.

UAVs are categorized into classes by weight (e.g., Group I, II, III, etc., among other described herein). Small UAVs are designated as being up to 20 pounds. The exemplary airspeed instrument apparatus and method are suitable for such class of UAVs as well as smaller and larger ones. In some embodiments, the exemplary airspeed instrument apparatus and method can be implemented for small drones (sub 5 pounds).

In an aspect, an apparatus for determining an airspeed of a UAV is disclosed comprising a sensor housing; an ingress, formed at a first end of the sensor housing, configured to receive a first airflow for a total pressure measurement; one or more circulation chambers, including a first circulation chamber (i.e., first TP chamber), operatively coupled to the ingress through an elongated tube, wherein the first circulation chamber defines a first volume for retaining the first airflow and separating moisture from the first airflow, the first circulation chamber comprising a first surface, defined in the first volume, with which the first airflow contacts to circulate in the first volume; at least one drainage port, including a first drainage port, extending from the first volume, wherein the first drainage port is configured to expel liquid of the separated moisture from the first airflow; and a first sampling port (e.g., protrusion, cylindrical boss) extending into the one or more circulation chambers and configured to direct a portion of the first airflow to a sensor located in the sensor housing, wherein the sensor is configured to provide a total pressure measurement using the first airflow, wherein the total pressure measurement is used, at a controller, in part, to compute an airspeed of the apparatus.

In some embodiments, the apparatus described herein further comprises a second circulation chamber (i.e., second TP chamber), operatively coupled to the first circulation chamber via an inclined tube, defining a second volume for receiving airflow from the first circulation chamber and separating moisture from said received airflow, the second circulation chamber comprising a second surface, defined in the second volume, with which the received airflow at the second circulation chamber contacts to circulate in the second volume; and at least one drainage port, including a second drainage port, extending from the second volume, the second drainage port configured to expel liquid from the first airflow in the second volume, wherein the first sampling port extends into the second circulation chamber.

In some embodiments, the apparatus described herein further comprises a static pressure chamber (i.e., SP chamber) having at least one static pressure ingress configured to receive a second airflow, wherein the static pressure chamber defines a third volume for retaining and separating moisture from the second airflow, the static pressure chamber including: at least one drainage port, including a third drainage port, extending from the third volume, the third drainage port configured to expel liquid from the second airflow in the third volume; and a second sampling port (e.g., static protrusion, cylindrical boss) formed of an extended structure protruding into the static pressure chamber and configured to direct the second airflow to the sensor for a static pressure measurement, wherein the static pressure measurement is combined with the total pressure measurement, at the controller, to compute the airspeed of the apparatus.

In some embodiments, the apparatus described herein further comprises a tube sampling port, formed on the elongated tube, wherein the tube sampling port has at least one static pressure ingress configured to receive a second airflow; and a static pressure chamber fluidically coupled to the tube sampling port, defining a third volume for retaining and separating moisture from the second airflow, the static pressure chamber comprising at least one drainage port, including a third drainage port, extending from the third volume, the third drainage port configured to expel liquid from the second airflow in the third volume; and a second sampling port (e.g., static protrusion, cylindrical boss) formed of an extended structure protruding into the static pressure chamber and configured to direct the second airflow to the sensor for a static pressure measurement, wherein the static pressure measurement is combined with the total pressure measurement, at the controller, to compute the airspeed of the apparatus.

In some embodiments, each of the one or more circulation chambers includes a surface, including the first surface, with which the airflow contacts to (i) cause circulation in the respective circulation chamber and (ii) separate moisture from the airflow, wherein said surface of the respective circulation chamber is a water-resistant surface.

In some embodiments, the first drainage port is horizontally extending from the first volume.

In some embodiments, the second drainage port is extending from the second volume at a rear end of the second circulation chamber.

In some embodiments, the first sampling port is vertically extending from a volume of the one or more circulation chambers.

In some embodiments, the sensor is a pressure transducer or a pressure insole.

In some embodiments, the first sampling port is vertically extending from the second volume of the second circulation chamber.

In some embodiments, the second sampling port is vertically extending from the third volume of the static pressure chamber.

In some embodiments, the second circulation chamber is located at a second end of the sensor housing.

In some embodiments, the static pressure chamber is located at the second end of the sensor housing, beneath the second circulation chamber.

In some embodiments, the apparatus described herein is configured for both wet and dry conditions for the UAV.

In another aspect, an airspeed sensor apparatus is disclosed comprising a sensor housing; an ingress, formed at a first end of the sensor housing, configured to receive a first airflow for a total pressure measurement; one or more circulation chambers, including a first circulation chamber and a second circulation chamber, operatively coupled to the ingress through an elongated tube, wherein the first circulation chamber defines a first volume for retaining the first airflow and separating moisture from the first airflow, and the second circulation chamber defines a second volume for receiving airflow from the first circulation chamber and separating moisture from said received airflow, the first circulation chamber comprising (i) a first surface, defined in the first volume, with which the first airflow contacts to circulate in the first volume and (ii) at least one drainage port, including a first drainage port, extending from the first volume, wherein the first drainage port is configured to expel liquid of the separated moisture from the first airflow; and a first sampling port (e.g., protrusion, cylindrical boss) extending into the one or more circulation chambers and configured to direct a portion of the first airflow to a sensor region located in the sensor housing, a static pressure chamber (i.e., SP chamber) having at least one static pressure ingress configured to receive a second airflow, wherein the static pressure chamber defines a third volume for retaining and separating moisture from the second airflow, the static pressure chamber comprising at least one drainage port, including a third drainage port, extending from the third volume, the third drainage port configured to expel liquid from the second airflow in the third volume; and a second sampling port (e.g., static protrusion, cylindrical boss) formed of an extended structure protruding into the static pressure chamber and configured to direct the second airflow to the sensor region for a static pressure measurement, a pressure sensor located in the sensor region and configured to measure the total pressure measurement using the first airflow and measure the static pressure measurement using the second airflow, wherein the total pressure measurement and static pressure measurement are combined to compute the airspeed of the apparatus.

In some embodiments, the apparatus described herein further comprising a tube sampling port, formed on the elongated tube, wherein the tube sampling port has at least one static pressure ingress configured to receive the second airflow and direct to the static pressure chamber.

In some embodiments, the sensor is a pressure transducer or a pressure insole. The pressure transducer may be a printed circuit board (PCB) mounted inside the aircraft that can read differential pressures.

In some embodiments, the first sampling port is vertically extending from the second volume of the second circulation chamber.

In some embodiments, the second sampling port is vertically extending from the third volume of the static pressure chamber.

In yet another aspect, an UAV (e.g., having a discrete or integrated airspeed sensor) is disclosed comprising a sensor or UAV housing; an ingress, formed at a first end of the sensor or UAV housing, configured to receive a first airflow for a total pressure measurement; one or more circulation chambers, including a first circulation chamber (i.e., first TP chamber), operatively coupled to the ingress through an elongated tube, wherein the first circulation chamber defines a first volume for retaining the first airflow, the first circulation chamber comprising a first surface, defined in the first volume, with which the first airflow contacts to circulate in the first volume; at least one drainage port, including a first drainage port, extending from the first volume, wherein the first drainage port is configured to expel liquid from the first airflow; and a first sampling port (e.g., protrusion, cylindrical boss), operatively coupled to the one or more circulation chambers, configured to lead the first airflow to a sensor located at a second end of the housing, wherein the sensor is configured to provide a total pressure measurement using the first airflow, wherein the total pressure measurement is used, at a controller, to compute an airspeed measurement of the UAV.

### BRIEF DESCRIPTION OF DRAWINGS

FIGS. 1A-1B each show an example apparatus for an airspeed instrument for total pressure measurement by employing one or more circulation chambers to separate moisture from the air in accordance with an illustrative embodiment.

FIGS. 2A-2D each show an example of an unmanned aerial vehicle configured with the exemplary weeping airspeed sensor of FIGS. 1A and 1B in accordance with an illustrative embodiment.

FIGS. 3A-3C show a detailed example design of the exemplary apparatus of FIG. 1B in accordance with an illustrative embodiment.

FIGS. 4A-4C show another detailed example design of the exemplary apparatus of FIG. 1A in accordance with an illustrative embodiment.

FIGS. 5A-5B show design considerations employed in a study to develop an exemplary weeping airspeed sensor in accordance with an illustrative embodiment.

FIGS. 6A-6J shows experimental results and evaluations of the exemplary weeping airspeed sensor employed in the study.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [l] refers to the first reference in the list. All references cited and discussed in this specification are incorporated herein by reference in their entirety and to the same extent as if each reference was individually incorporated by reference.

### Example Apparatus

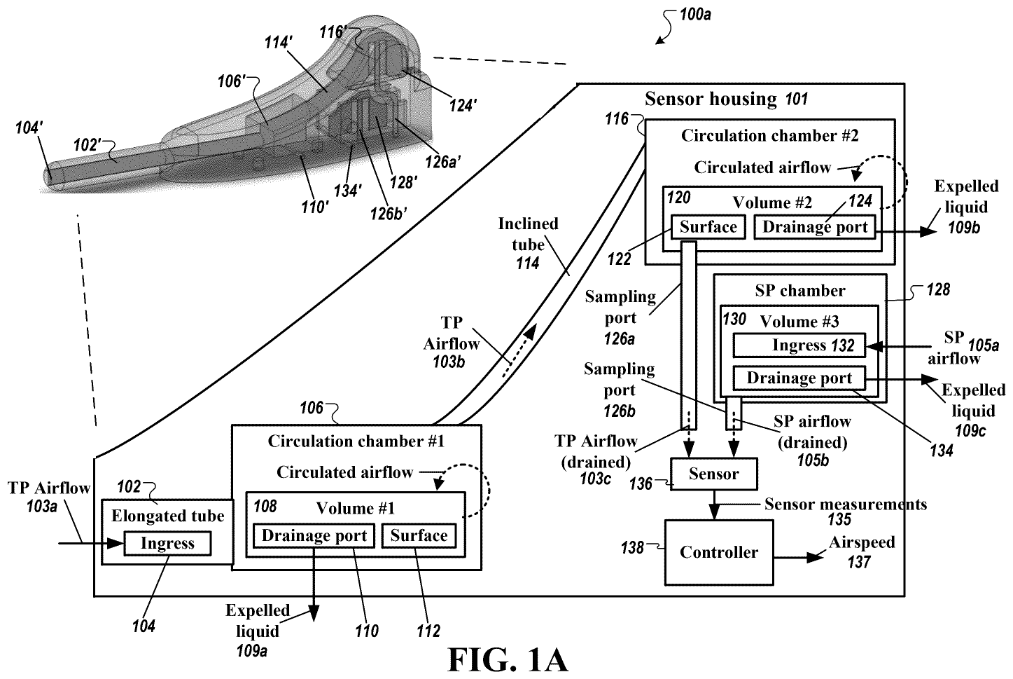

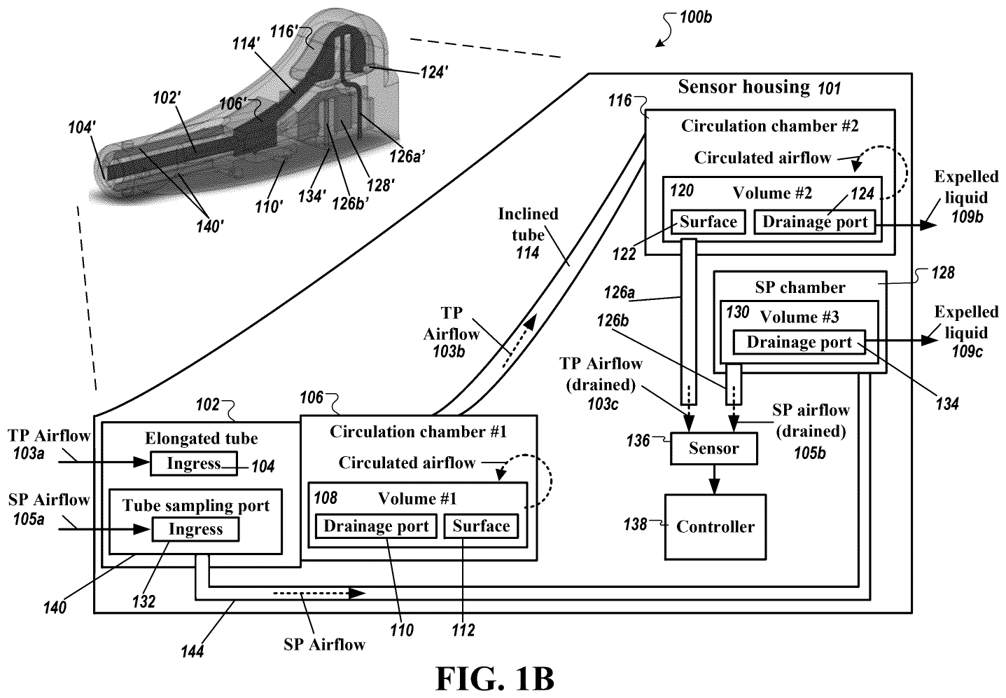

FIGS. 1A-1B each shows an example apparatus 100 (shown as 100a, 100b) for an airspeed instrument for total pressure measurement by employing one or more circulation chambers to separate moisture from the air in accordance with an illustrative embodiment. In FIGS. 1A and 1B, the apparatus 100a, 100b each has a sensor housing 101 having an ingress 104 forming at a first end of the sensor housing to receive total pressure (TP) airflow 103 (i.e., airflow for TP measurements). The airflow 103 is directed into one or more circulation chambers (shown as 106 and 116) that separate moisture from the air. The circulation chamber is integrated with a sampling port that samples a portion of the air to provide a TP measurement.

The apparatus 100a, 100b may be configured with a static pressure (SP) chamber 128. The static pressure chamber 128 may have an integrated sampling port for SP measurement.

The sampling ports 126a, 126b are each connected to a respective a sensor 136 (e.g., pressure transducer, pressure insole) configured to measure pressures 135 of the respective airflows/pressures. The apparatus 100a, 100b may connect to a sensor controller 138. The sensor may provide a computed airspeed 137 to the controller (as a digital or analog signal) as a difference between the measured TP and SP, or the sensor may provide individual measurements for the controller 138 to calculate.

In FIG. 1A, the SP chamber 128 has one or more ingress 132, separate from the TP chamber, to receive a SP airflow 105a (i.e., airflow for SP measurements). In FIG. 1B, the SP chamber 128 is fluidically coupled to a tube sampling port 140 and receives the SP airflow 105a from the ingress(es) 132 formed on the tube sampling port 140. In FIG. 1B, the SP chamber 128 is fluidically coupled to the tube sampling port 140 (shown as 140′) that is centrically formed on the elongated tube 102 and has at least one SP ingress 132 configured to receive the SP airflow 105a into the tube sampling port 140. The SP chamber 128 defines the volume 130 for retaining the SP airflow 105a flowing from the tube sampling port 140 via a fluidic tube connection 144.

In an embodiment, the sampling port 126b can vertically extend from the volume 130 of the SP chamber 128. In another embodiment, the SP chamber 128 can be located at the second end of the sensor housing 101, beneath a rear portion of the circulation chamber 116 (also referred to as a second circulation chamber), and proximal to the sensor 136 and the sensor 138.

Circulation Chambers (106, 116). In the examples shown in FIGS. 1A-1B, the circulation chamber 106 (shown as 106′), as a separation chamber, is operatively coupled to the ingress 104 (shown as 104′) via an elongated tube 102 at the first end of the sensor housing 101. The first circulation chamber 106 defines a volume 108 having a surface 112 (e.g., having waterproof wall boundaries) configured to retain and keep the TP airflow 103a circulating in the volume 108 after the TP airflow 103a enters the elongated tube via the ingress 104 and reaches the circulation chamber 106. The first circulation chamber 106 is configured with at least one drainage port 110 (e.g., orifice) (shown as 110′), extending from the volume 108, that expels separated liquid and moisture (shown as 109a) from the TP airflow 103a as the TP airflow 103a circulates in the volume 108. The TP airflow, or a portion thereof, with the separated liquid and moisture (shown as 103b), as shown in this embodiment, travels to a second portion of the second circulation chamber 116 through an inclined tube 114 (shown as 114′), or channel. In some embodiments, the drainage port 110 can horizontally extend from the volume 108, e.g., include stepped surfaces.

The second circulation chamber 116 (shown as 116′) is operatively coupled to the first circulation chamber 106 via the inclined tube 114. The second circulation chamber 116 defines a second volume 120 having a surface 122 configured to retain and keep the TP airflow 103b circulating in the second volume 120 after the TP airflow 103b enters the inclined tube 114 (from the circulation chamber 106) and reaches the second circulation chamber 116. The second circulation chamber 116 includes at least one drainage port 124 (e.g., orifice) (shown as 124′), extending from the volume 120, that expels additional liquid and moisture (shown as 109b) from the TP airflow 103b as the TP airflow 103b circulates in the volume 120. The TP airflow, or a portion thereof, with no liquid or moisture (shown as drained TP airflow 103c), then enters the sampling port 126a (e.g., protrusion, cylindrical boss) (shown as 126a′) extending into the volume 120 and reach the sensor 136 located in a second end of the sensor housing 101. The sensor 136 is a pressure transducer configured to measure the pressure of the TP airflow 103c and transmit the TP pressure measurement to the controller 138 as a first part of a computation for the airspeed 137 of the apparatus 100. The pressure transducer may be a printed circuit board (PCB) mounted inside the aircraft that can read differential pressures.

As shown in FIGS. 1A and 1B, the drainage port 124 extends from the volume 120 at a rear end of the second circulation chamber 116. The second circulation chamber 116 in the example is shown located proximal to the sensor 136 and the controller 138. The sampling port 126a is shown vertically extending from the volume 120 of the second circulation chamber 116. In other embodiments, the drainage ports 124 extends from the side of the second circulation chamber 116. The second circulation chamber 116 can be located at the second end of the sensor housing 101, proximal to the sensor 136 and the controller 138.

In alternative embodiments, the first and second circulation chambers 106, 116 may be implemented as a single chamber/volume.

Static Pressure Chamber (128). In FIG. 1A, the static pressure (SP) chamber 128 (shown as 128′) has at least one static pressure ingress 132 configured to receive a static pressure (SP) airflow 105a (i.e., airflow for SP measurement). As noted herein, the SP chamber and associated structure are optional to the apparatus 100a, 100b and may be implemented in a separate sensor.

In the example shown in FIG. 1A, the SP chamber 128 defines a volume 130 for retaining the SP airflow 105a when the SP airflow 105a enters the SP chamber 128 directly through the SP ingress(es) 132. The SP chamber 128 can have at least one drainage port 134 (e.g., orifice) (shown as 134′), extending from the volume 130, that expels liquid and moisture (shown as 109c) from the SP airflow 105a when the SP airflow 105a is in the volume 130. The SP airflow, or a portion thereof, with nearly no liquid or moisture (shown as drained SP airflow 105b), then enters the sampling port 126b (e.g., protrusion, cylindrical boss) (shown as 126b′) extending into the volume 130 and reach the sensor 136 located in the second end of the sensor housing 101. The sensor 136 then measures the pressure of the SP airflow 105b and provides the SP pressure measurement to the controller 138 as a second part of the computation for the airspeed 137 of the apparatus 100.

The airspeed 137, computed by the controller 138 using the sensor measurements 135 (e.g., TP measurement, SP measurement), can be subsequently used for local or remote monitoring and/or controlling a small unmanned aerial vehicle (UAV), including drones and UAVs in unmanned aerial vehicle (UAV).

When Bernoulli's equation is applied, the airspeed can be calculated in Equation 1 using the dynamic pressure and air density [5], [6], wherein V₂=0 at stagnation points.

$$\frac{{V}_{1}^{2}}{2 g} + \frac{{p}_{1}}{γ} = \frac{{p}_{2}}{γ} \to {V}_{1} = \sqrt{\frac{2}{p}} ( {p}_{2} - {p}_{1} ) \qquad ( Eq . 1 )$$

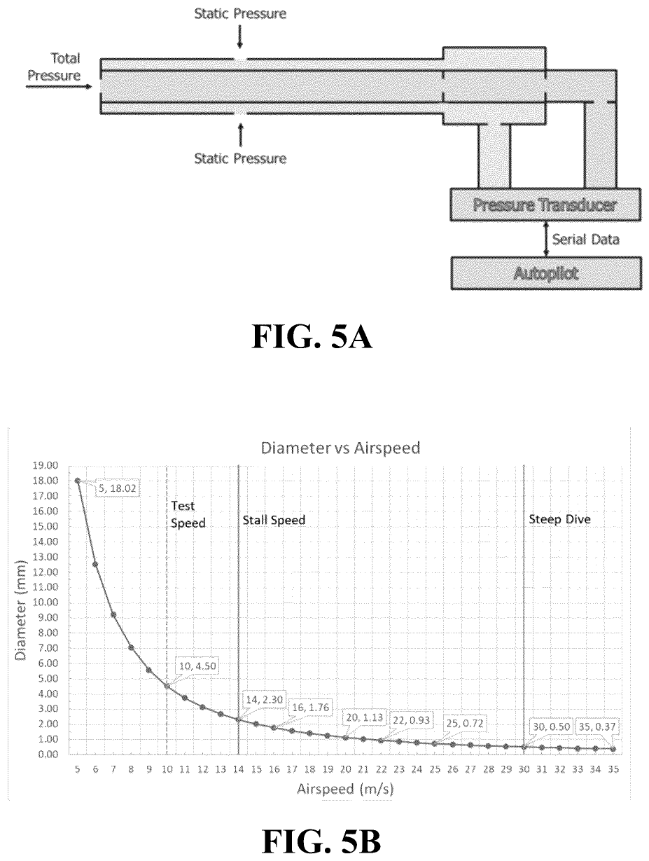

Orifice Diameter. The orifice sizes of the total and static pressure intakes can be adjusted to mitigate droplet adhesion within the orifice proper and within the plumbing of the sensor. Internal sizing can be maximized to increase the volumetric flow rate through the sensor. If the orifice size is sufficiently large and the aircraft is moving above a threshold velocity, the aerodynamic forces of the incoming air can overcome the surface tension acting on the water droplets. Thus, the aerodynamic forces can clear the orifice from obstruction. The pressure required by incoming air acting on the droplet can be calculated using Laplace's Law for a spherical membrane in Equation 2 at known velocity vₐᵢᵣ and air density ρₐᵢᵣ=1.293 kg/m³. The calculated pressure and the surface tension of water, γ_{H20}=0.073 N/m, can be used in Equation 3 to determine the minimum required radius of the orifice [9], [10]. FIG. 5B shows example associated diameters for vₐᵢᵣ in the range [1, 35] m/s, representing common sUAV operating airspeeds.

$$Δ P = \frac{1}{2} {ρ}_{air} {v}_{air}^{2} \qquad ( Eq . 2 )$$

$${r}_{orifice} = 2 \frac{{γ}_{{H}_{2} O}}{Δ P} \qquad ( Eq . 3 )$$

The operational velocity range for a general sUAV can be approximated as [14, 30] m/s, where 14 m/s is a typical landing speed and 30 m/s is indicative of a steep dive.

Material and Surface Roughness. Capillary action can occur when polarized water molecules from precipitation are more attracted to the internal boundary material of the sensor than to the surrounding water molecules [10], which causes the water to adhere to the inside boundaries of the sensor, leading to internal pooling. The attraction of the water molecules to the boundary material causes a force against the pull of gravity that may lead to vertical droplet creepage along the edges of the fluid, which is undesirable as the mass flow rates of the water entering and exiting the sensor are ideally equivalent, resulting in no retained water. The accumulation of water within the sensor can be inversely related to the ease of pressure transmission. As more moisture adheres to the internal plumbing, surface tension binds the droplets together, thus resisting the aerodynamic forces of the air. Additionally, vertical creepage of water along internal boundaries offsets the effectiveness of the dams, further hindering the wicking potential of the sensor.

The material properties of the boundary can be considered in controlling water adhesion and capillary action. Nonpolarized metal castings or injection-molded plastics may form highly smooth and seamless surfaces capable of resisting water adhesion. However, the former can be costly and hefty in weight, while the latter can be difficult to fabricate at a non-production quantity. Considering cost, ease of fabrication, and resolution, 3D printing can be the most desirable approach.

Acrylonitrile butadiene styrene (ABS) and polylactic acid (PLA) are abundant materials and easy to 3D print but have a hydrophilic affinity to water [11]. The surface hydrophobicity may be altered using a fluoropolymer or a silicone coating [12], which may increase design complexity, risk, and cost. Coating intricate internal geometries in a bath may require centrifugal, vibrational, or another method of drying in which clumping is guaranteed not to occur. Instead, hydrophobic 3D-printable fused deposition modeling (FDM) filament intrinsically contains these properties without requiring special coatings.

Fluorinated ethylene propylene (FEP) has good hydrophobic and UV properties as a non-polar thermoplastic and can be easier to 3D print than similar materials (e.g., polytetrafluoroethylene (PTFE)) [13]. However, FEP, in addition to nylon FDM filaments, is difficult to procure and incompatible with nonindustrial 3D printers. Instead, a compromise filament retains the hydrophobic properties of FEP but can be used on tabletop printers. PC/PTFE is a naturally hydrophobic composite filament with a polycarbonate (PC) base with PTFE (Teflon) additive [14], which is mechanically resistant to deformation and commonly used in applications requiring highly-smooth low-friction surfaces [15]. PC/PTFE is a hot-extruded FDM filament with a nozzle temperature of 265-295° C. and a bed temperature of 95-120° C. [16]. PC/PTFE may require special high-temperature enclosed-volume FDM printers, but remain compatible with nonindustrial tabletop units.

In contrast to FDM processes, which exhibit lower resolution and greater surface roughness, stereolithography (SLA) can be an additive 3D printing process that focuses an ultraviolet (UV) laser on a bath of thermoset fluid to harden the plastic in the desired shape. The print can be washed of excess liquid resin in a solvent bath, such as isopropyl alcohol (IPA), and undergoes post-hardening during a final curing cycle. The result can be a hardened 3D structure exhibiting superior resolution to traditional FDM products [17]. The higher print resolution lowers internal boundary surface roughness and thus aids in the wicking properties of the weeping pitot-static tube.

Verticality and Drainage. As shown and described in the various embodiments, the exemplary apparatus 100a, 100b may employ dam-like slopes to redirect the entering air-water mixture to separate the moisture for drainage. The verticality of the dam structures also redirect the incoming air into disk-shaped dissipative cavities. The air is free to circulate within the reservoirs, which separates the water from the mixture, facilitating the liquid to pool at the bottom. Drain holes can be situated at the lowest possible points of the internal reservoirs—high-pressure regions—such that water is forced out of the sides of the probe via gravity and the formed pressure head. While the drain holes can be smaller in diameter than the intakes, the pressure gradient can ensure adequate flow rate without clogging. The verticality of the internal dams resists capillary action, ensuring that liquid creepage does not reach the final channels containing the brass pickup barbs and, by extension, the transducer.

### Example Small Unmanned Aerial Systems or Unmanned Aerial Vehicle

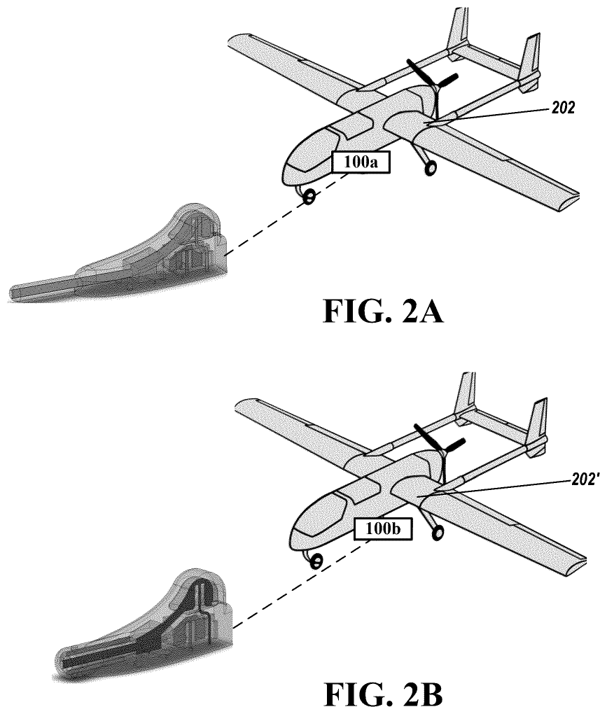

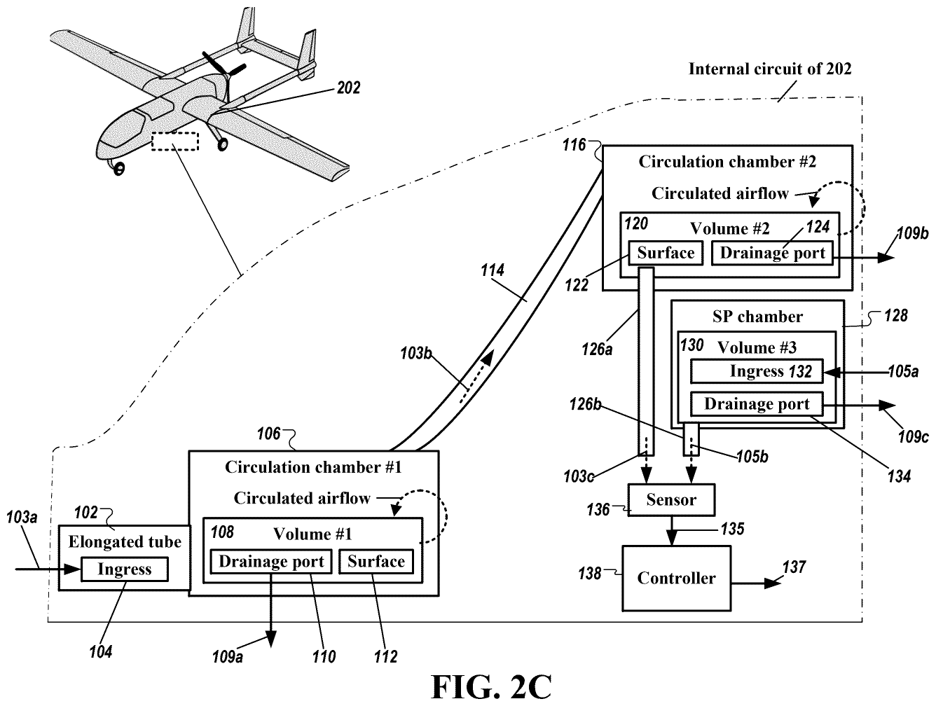

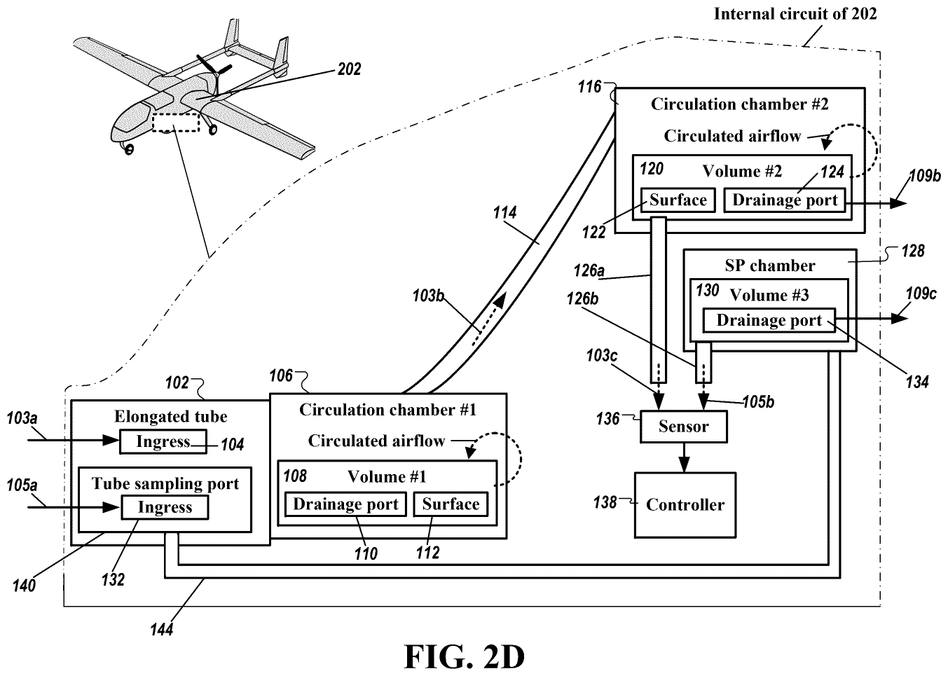

FIGS. 2A-2B each shows an example of the apparatus 100a-100b mounted/attached on a small UAV 202 (e.g., drones) (shown as 202′). The UAV may be any one of UAV groups 1-2, where group 1 includes any UAVs with a maximum weight of 20 lb and a maximum speed of 100 kn, and group 2 includes any UAVs with a maximum weight of 21-55 lb and a maximum speed of 250 kn. Group 3 class UAS are also refer to having greater than 55 lbs but less than 1320 lbs. As shown, the apparatus 100a-100b can be mounted on the UAV 202 (shown as 202′) as an extra module/device to determine the airspeed 137 of the UAV 202.

FIGS. 2C-2D each shows an example direct integration of components of the apparatus 100a-100b into the frame of the UAV 202 (e.g., drones), e.g., where the UAV was 3D printed or molded/fabricated with the sensor structures defined in the frame. In some embodiments, the apparatus 100a, 100b is mounted to an aircraft fuselage using a 3D printed adapter. As shown in FIGS. 2C and 2D, the sensors component (e.g., 102, 106, 114, 116, 128, 126, 136, 138, 140) of each are directly integrated into the internal circuit of the small UAV 202 to become a part of the UAV 202, without any housing (101 in FIGS. 1A-1B).

### Example Weeping Airspeed Sensor Design

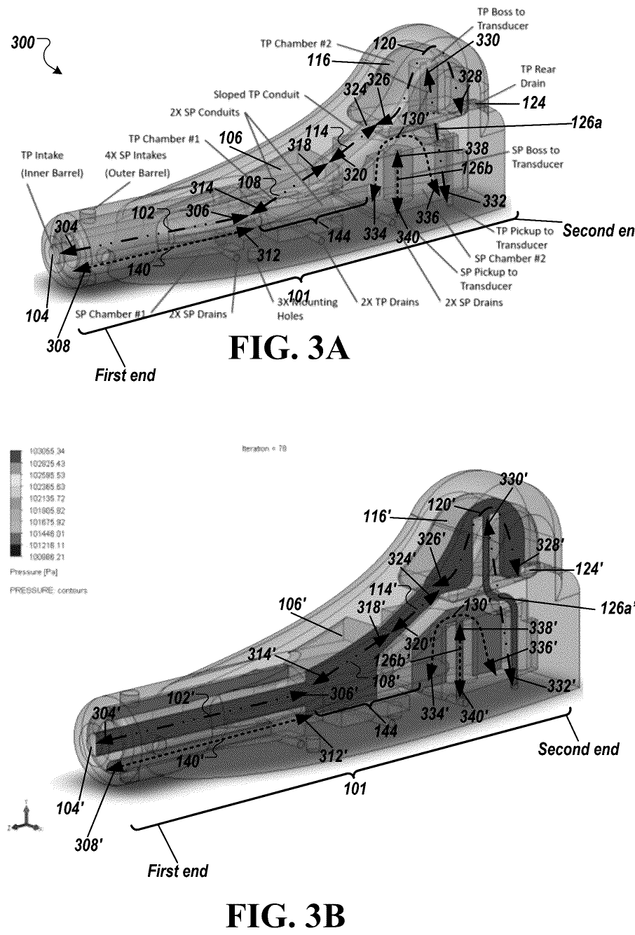

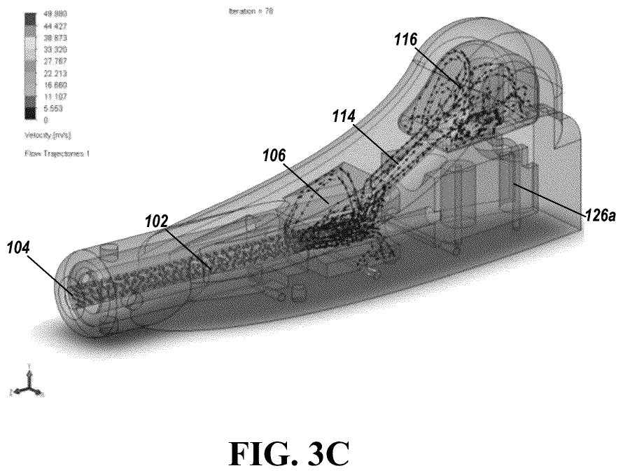

Weeping Airspeed Sensor #1. FIGS. 3A-3B show an example weeping airspeed sensor 300 for the exemplary apparatus (also referred to as a weeping sensor). As shown, the exemplary apparatus has a sensor housing 101 configured to contain all components (e.g., circulation chambers, static chambers, sensors, etc.) of the exemplary apparatus.

In the example shown in FIGS. 3A-3B, the apparatus has an ingress 104 (shown as 104′) located at a first end of the sensor housing 101 and operatively coupled to a proximal end 304 (shown as 304′) of an elongated tube 102 (shown as 102′, TP intake, inner barrel). The ingress 104 is configured to receive TP airflow (i.e., airflow for TP measurement) and direct the TP airflow, via the proximal end 304, into the elongated tube 102 to later reach a distal end 306 (of the elongated tube 102) operatively coupled to a proximal end 314 of a circulation chamber 106 (shown as TP chamber #1). The portion between the proximal end 304 and distal end 306 of the elongated tube 102 is centrically surrounded by a tube sampling port 140 (shown as SP chamber #1) (e.g., hollow cylinder, i.e., outer barrel) configured to receive SP airflow (i.e., airflow for SP measurement, may contain liquid and moisture) via a plurality of SP ingresses (e.g., 4 SP intakes/orifices) formed thereon (e.g., on the sides of tube sampling port 140). The proximal end 308 of the tube sampling port is located proximal to the ingress 104, and the distal end 312 of the tube sampling port is located proximal to the distal end 306 and fluidically coupled, via one or more fluidic connections 144 (e.g., 2 SP conduits flanking the circulation chamber 106), to a SP chamber 128 located at a second end of the sensor housing 101. Each SP ingress (e.g., orifice) may have a minimum diameter of 2.3-4.5 mm, depending on the velocity (e.g., 4-14 m/s) of the small UAV that employs the apparatus. In some embodiments, the tube sampling port 140 can have a plurality of drainage ports (e.g., 2 SP drains), extending from the portion between the proximal end 308 and distal end 312, configured to expel liquid and moisture from the SP airflow.

An example minimum diameter is 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, 4.0 mm, 4.1 mm, 4.2 mm, 4.3 mm, and 4.4 mm

The circulation chamber 106 (shown as TP chamber #1, 106′) defines a volume 108 (shown as 108′), between a proximal end 314 and a distal end 318, configured to retain the TP airflow that exits the elongated tube 102 via the distal end 306 and enters the chamber 106 via the proximal end 314, where the distal end 306 and proximal end 314 are operative coupled to each other. The volume 108 can have a flat surface defined by one or more waterproof boundary walls and configured to keep the TP airflow circulating to separate the moisture therein. The circulation chamber 106 includes at least one drainage port (e.g., TP drains/orifices), extending from the volume 108, configured to expel liquid and moisture from the TP airflow circulating therein. The distal end 318 of the circulation chamber 106 is operatively coupled to a proximal end 320 of an upward-inclined tube 114 (shown as 114′) so that the TP airflow exiting the circulation chamber 106 can enter, via the proximal end 320, the upward-inclined tube 114 and reach a distal end 324 of the inclined tube. The proximal end 320 is operatively coupled to the distal end 318 at a location higher than the bottom of the circulation chamber 106. The distal end 324 is operatively coupled to a proximal end 326 of the second circulation chamber 116 (shown as TP chamber #2) so that the TP airflow can enter the circulation chamber 116, via the proximal end 326, after reaching the distal end 324.

The second circulation chamber 116 (shown as TP chamber #2, 116′) defines a volume 120 (shown as 120′), between the proximal end 326 and the distal end 328, configured to retain the TP airflow that exits the upward-inclined tube 114 via the distal end 324 and enters the chamber 116 via the proximal end 326, wherein the distal end 324 and proximal end 326 are operative coupled to each other. The volume 120 preferably includes an upward-curved surface defined by a plurality of waterproof boundary walls and configured to keep the TP airflow circulating. The second circulation chamber 116 can have at least one drainage port (e.g., TP rear drain/orifice 124, 124′), extending from the rear of volume 120 and configured to expel liquid and moisture from the TP airflow circulating and separated in the volume therein. In some embodiments, the second circulation chamber 116 is located above the static chamber 128 at the second end of the sensor housing 101. The second circulation chamber 116 has a sampling port 126a (e.g., TP boss) (shown as 126a′) vertically extending from the middle of the volume 120 between the proximal end 326 and the distal end 328. The sampling port 126a, with an upper end 330 (shown as 330′) protruding into the volume 120 and a lower end 332 (shown as TP pickup to transducer, 332′) located above a sensor (shown as 136 in FIGS. 1A-1B) at the second end of the sensor housing, is configured to collect, via the upper end 330, the TP airflow in the volume 120 and direct, via the lower end 332, the TP airflow to the sensor for TP measurement. The portion between the upper end 330 and lower end 332 of the sampling port 126a can have a curved shape around the static chamber 128.

The static pressure (SP) chamber 128 (shown as SP chamber #2), located beneath the second circulation chamber 116 at the second end of the sensor housing 101, has (i) a proximal end 334 (shown as 334′) fluidically coupled, via one or more fluidic connections 144, to the tube sampling port 140 and (ii) a distal end 336 (shown as 336′) proximal to the sampling port 126a. The SP chamber 128 defines an upward-curved volume 130 (shown as 130′) between the proximal end 334 and the distal end 336 to retain the SP airflow that exits one or more fluidic connections 114 and enters the SP chamber 128 via the proximal end 334. The SP chamber 128 can have one or more drainage ports (e.g., 2 SP drains/orifices), horizontally extending from the volume 130, configured to expel liquid and moisture from the SP airflow in the volume 130. The SP chamber 128 has a sampling port 126b (shown as 126b′) vertically extending from the middle of the volume 130 between the proximal end 334 and the distal end 336. The sampling port 126b, with an upper end 338 (shown as 338′) protruding into the volume 130 and a lower end 340 (shown as SP pickup to transducer, 340′) located above the sensor 136, is configured to collect, via the upper end 338, the SP airflow in the volume 130 and direct, via the lower end 340, the SP airflow to the sensor for SP measurement.

In some embodiments, the apparatus can have one or more mounting holes (e.g., 3 mounting holes) located at the bottom of the sensor housing 101 so that the apparatus can be mounted on a small UAV to measure the airspeed of the UAV.

FIG. 3C shows an example TP airflow throughout the apparatus in sensor 300. As shown, the TP airflow enters the apparatus via the ingress 114, travels through the elongated tube 102, enters and circulates in the circulation chamber 106, travels through the inclined tube 114, enters and circulates in the second circulation chamber 116, and reaches the sensor (not shown) via the sampling port 126a.

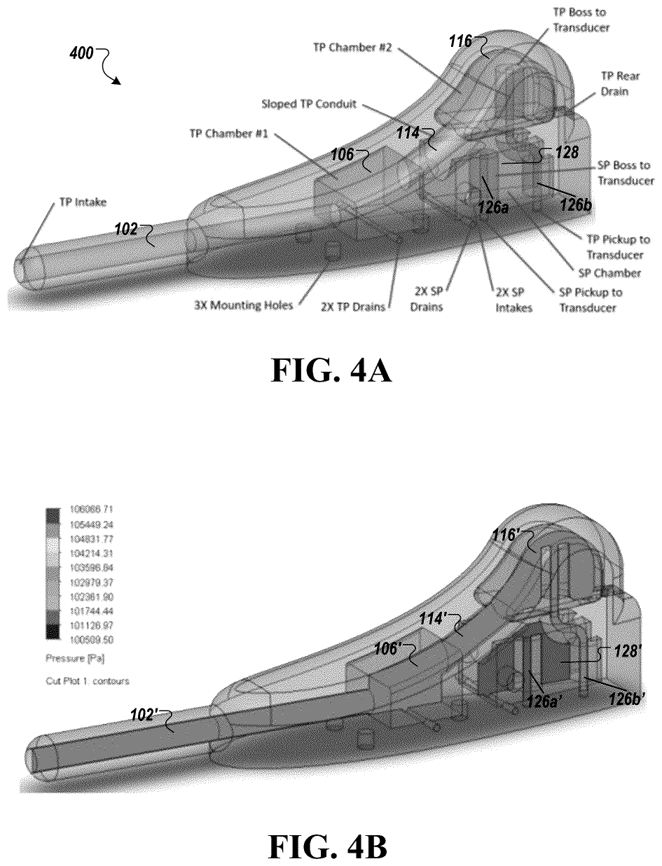

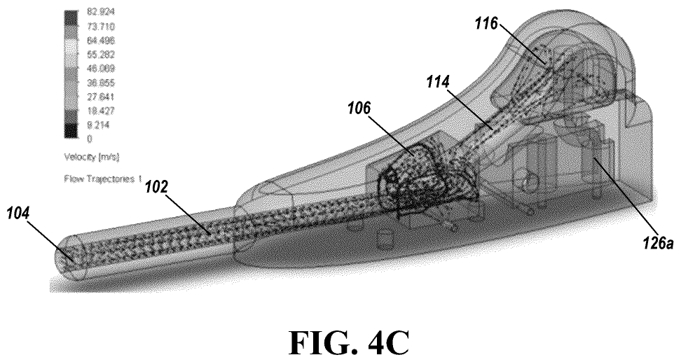

Weeping Airspeed Sensor Design #2. FIGS. 4A-4B show another example weeping airspeed sensor 400 for the exemplary apparatus. As shown, the sensor 400 has the same mechanical configurations for the elongated tube 102 (shown as 102′), circulation chambers 106 and 116 (shown as 106′ and 116′), the inclined tube 114 (shown as 114′), and the sampling ports 126a (shown as 126a′) and 126b (shown as 126b′). However, the apparatus in sensor 400 has no tube sampling port (shown as 140 in FIGS. 3A-3B) surrounding the elongated tube 102 and operatively coupled to the SP chamber 128. The SP chamber 128 does not rely on any tube sampling ports for SP ingresses, as in sensor 300, because the SP chamber 128 has its own static pressure ingresses (e.g., 2 SP intakes) to receive a static pressure (SP) airflow in sensor 400.

FIG. 4C shows an example TP airflow throughout the apparatus in sensor 400. As shown, the TP airflow enters the apparatus via the ingress 114, travels through the elongated tube 102, enters and circulates in the circulation chamber 106, travels through the inclined tube 114, enters and circulates in the second circulation chamber 116, and reaches the sensor (not shown) via the sampling port 126a.

### EXPERIMENTAL RESULTS AND ADDITIONAL EXAMPLES

A study was conducted to develop a low-cost pitot-static tube for the sUAV platform as a rapidly manufactured 3D printed weeping airspeed sensor. The study fabricated the weeping sensor validated in a testing environment employing pitot tube theory to support water management while considering aerodynamic effects and capillary action to mitigate the likelihood of clogging at typical sUAV flight speeds ranging from 14 m/s to 30 m/s. The study calculated minimum orifice size, in addition to the minimum wall thickness required by additive manufacturing, and selected final volumetric sizing of two leading sensor designs. Certain embodiments combined the total and static intakes on a wide forward barrel, while other embodiments replicated full-scale aircraft design by moving the static intakes to the sides of the probe. The study considered two 3D printing materials—FDM PC/PTFE filament and SLA resin—for implementation.

Prior pitot-tube airspeed sensor. FIG. 5A shows a diagram for an example pitot-tube airspeed sensor for UAVs, from which the exemplary apparatus improves. The pitot-tube sensor includes a narrow tube that protrudes from the aircraft into the oncoming free stream of air. The tube can have two orifice types: the singular intake (i.e., ingress) on the forwardmost end of the (pitot) probe/tube, which measures total stagnation pressure (i.e., total pressure (TP)), and the static pressure port(s) on the outer side walls. Total and static pressures remain isolated as they are conveyed through the housing of the sensor and to a pressure transducer mounted within the fuselage of the aircraft. The transducer measures two pressures and provide an analog input to the onboard autopilot. Dynamic pressure can be calculated from the difference between total and static pressure.

Any blockages within the structure of the pitot-static tube or its downstream plumbing may result in partial pressure, trapped pressure, or complete pressure loss at the transducer [7]. The orifices on the traditional probe are limited to the total and static intakes only, so any moisture accumulating within the sensor becomes trapped. Additionally, the intake diameters are small enough that it is difficult for aerodynamic forces to overcome any surface tension and capillary action on water droplets accumulated within the orifice. Generally, sUAV platforms do not operate at velocities great enough for aerodynamics to overcome the microforces acting on the accumulated droplets within hobby-grade pitot-static tubes.

The weeping pitot-static design can use the same principles as the traditional tube, but add the capability of expelling accumulated moisture from the probe [8]. The management of water allows for the aircraft to operate in IMC or near-IMC conditions without high risk of pressure interruptions. The wicking effect can be achieved by altering several variables of the traditional sensor design, namely, orifice size, material surface roughness, verticality, and drainage capacity.

Additive Manufacturing. The study evaluated the performance of fused deposition modeling (FDM) and stereolithography (SLA) additive fabrication technologies in weeping pitot-static applications. For the FDM material, polycarbonate (PC)/polytetrafluoroethylene (PTFE) was selected for its hydrophobicity, durability, obtainability, compatibility with tabletop printers, and its low surface roughness relative to other FDM filaments. Table 1 provides the characteristics of each pitot-static tube, including the corresponding test identifier (ID) for each.

TABLE 1

| | | | Bounding box: | Mass |
|---|---|---|---|---|
| Barrel type | Material | ID | L × W × H | (g) |
| Combined | PC/PTFE | A | 107.6 × 27.4 × 40.2 | 41.8 |
| Separated | PC/PTFE | B | 123.8 × 25.2 × 36.9 | 20 |
| Combined | Resin | C | 107.6 × 27.4 × 40.2 | 80.3 |
| Separated | Resin | D | 123.8 × 25.2 × 36.9 | 35.8 |

The PC/PTFE prints exhibited extensive bed adhesion issues due to the high thermal properties of the material. Using an enclosed high-temperature Creality CR-5 Pro H with full raft, optimized slicer settings, and standard glue stick adhesive, the print failed before the raft structure was completed. The 110° C. maximum bed temperature of the CR-5 was insufficient to maintain internal material temperatures. The raft would consequently cool, contract, and peel off the bed [18]. Ultimately, the application of a stronger adhesive specifically designed for FDM printing (e.g., Dimafix™) proved successful in maintaining consistent adhesion to the bed plate.

The quality of the FDM prints was consistent and free of error. One sensor in the prints did experience a 200 μm horizontal layer offset at y=22.9 mm from the baseplate, but the shift was inconsequential to the operation of the sensor. A light sanding was applied to the outer surface, the drain holes and outlets to the transducer were reamed to size, and all orifices were tested for continuity.

The selected SLA photoreactive resin was Formlabs Clear Resin V4 printed at 100 μm print resolution. The clear resin variant was selected to provide limited viewing of the internal geometries of the probe during operation. Both SLA probes were printed simultaneously in 36 hours. The increased fabrication time was offset by the resolution, though the burrs left by the support lattice required extensive sanding and polishing, which added time to the post-processing process. As with the FDM prints, the drain and outlet holes required reaming and were tested for proper airflow.

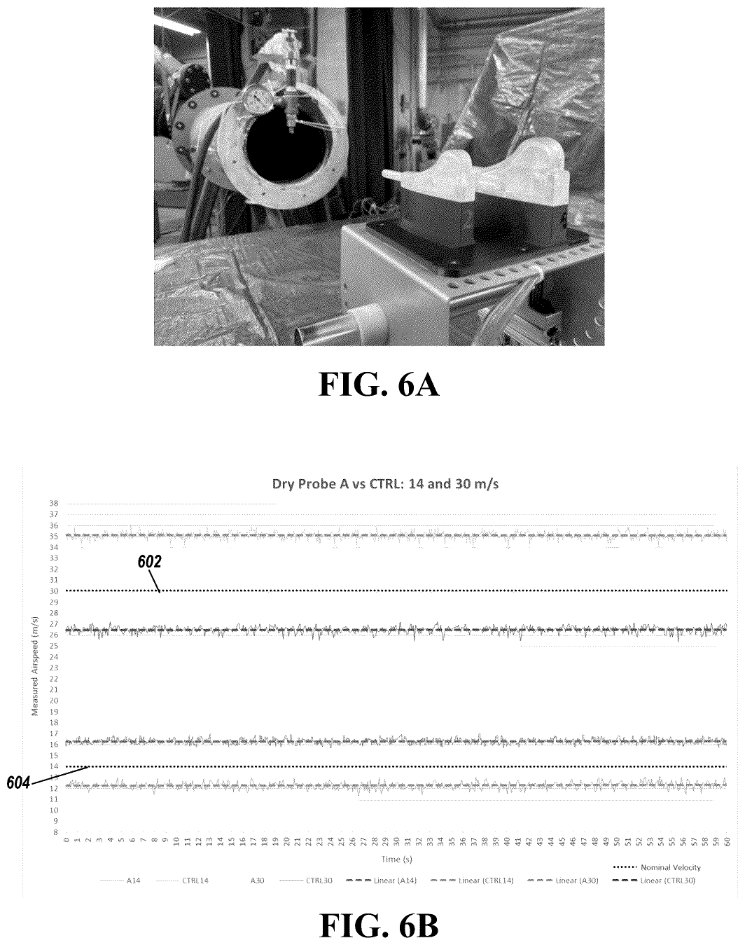

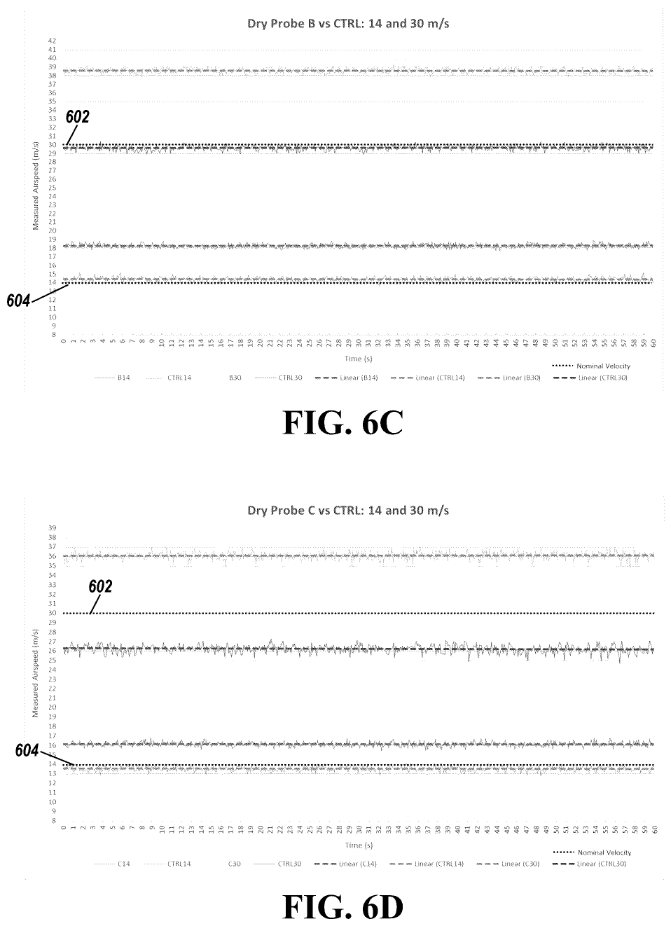

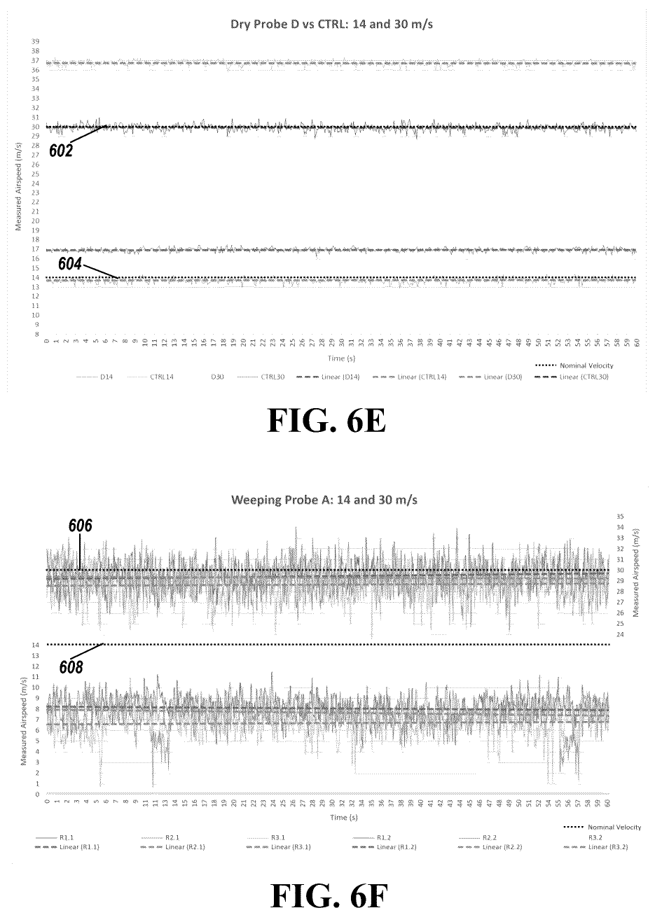

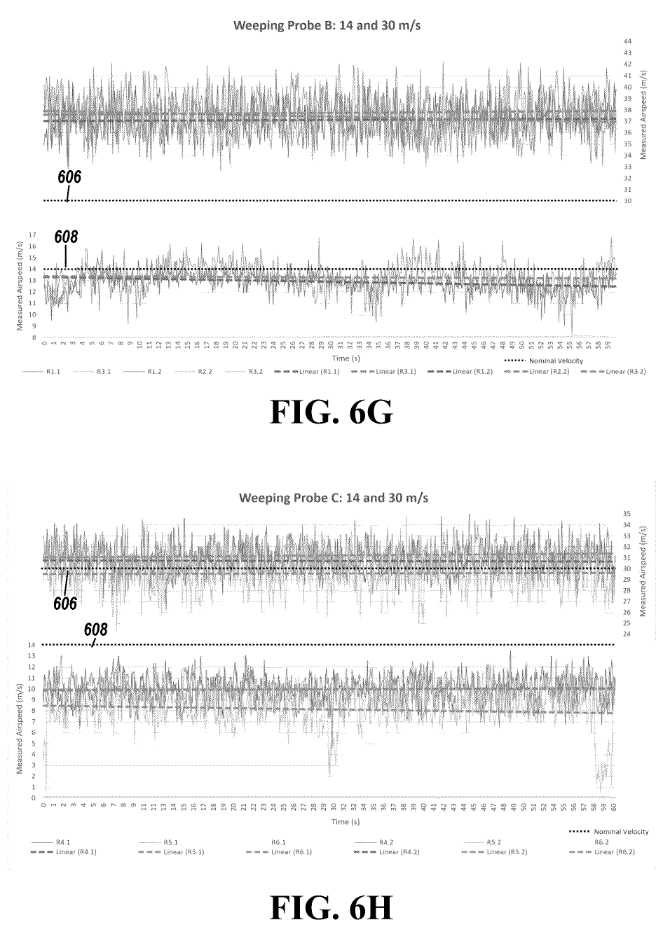

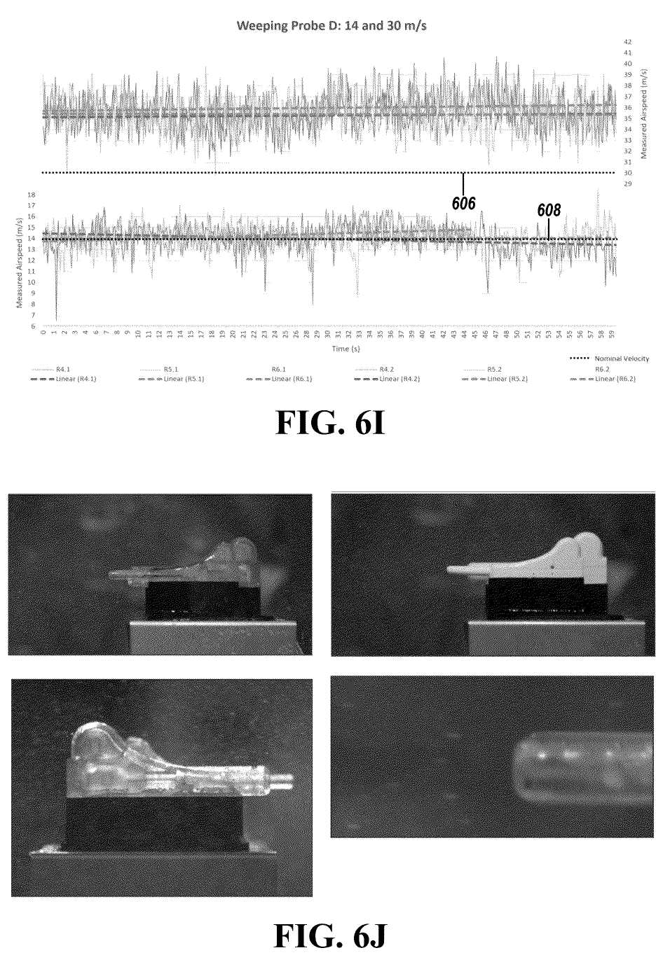

Test Stand Design. A 3D printed mount in the study included two test probes simultaneously: one combined and one separated barrel configuration. As the mount did not impact the sensor performance, FDM ABS was used to ease fabrication and cost. The probe-mount assembly was fastened to a bent water jet sheet of 5052 AL such that the 0.0625″ plastic tubing could be routed out of the bottom of the stand to the transducers. FIG. 6A shows the completed assembly that stood in front of a high-speed air blower and secured to a test bench.

Design of Experiments. The exemplary apparatus was adapted from the Society of Automotive Engineers (SAE) International standard AS5562 on the testing of full-scale pitot-static tubes in rainy and icy conditions [20]. Several parameters specified in the standard did not translate to sUAV operating conditions and thus were modified for sUAV application in Table 2. Table 2 shows the adapted AS5562 rain test conditions [20].

TABLE 2

| Test | Probe | Airspeed | LWC | Altitude | Temp | MVD | Duration |
|---|---|---|---|---|---|---|---|
| condition | ID | (m/s) | (g/m³) | (m) | (° C.) | (μm) | (s) |
| R1.1 | A | 14 | 1-4 | 320 | 15-30 | 200-1000 | 60 |
| R1.2 | B | 30 | | | | | |
| R2.1 | A | 14 | 5-7 | | | | |
| R2.2 | B | 30 | | | | | |
| R3.1 | A | 14 | 14-17 | | | | |
| R3.2 | B | 30 | | | | | |
| R4.1 | C | 14 | 1-4 | | | | |
| R4.2 | D | 30 | | | | | |
| R5.1 | C | 14 | 5-7 | | | | |
| R5.2 | D | 30 | | | | | |
| R6.1 | C | 14 | 14-17 | | | | |
| R6.2 | D | 30 | | | | | |

In Table 2, MVD, or VMD, is the liquid median volumetric diameter measured in microns (μm) and represents the median diameter of water droplets injected into an airstream containing the test units. The droplet MVD for each test case was measured and verified using a high-speed camera.

Liquid water content (LWC) was expressed as a density or water mass per cubic meter of air. Each probe was tested at the two target velocities and three LWC values for a total of twelve test cases. For each pair of test cases, the droplet injector system was calibrated to the specified LWC and verified via a collection routine.

The LWC variable was determined by installing a polyvinyl chloride (PVC) pipe with a known inner diameter centered on the blower at the same proximity as the test units. The pickup fed below the test bench to a collection reservoir. A cover was installed on the pickup, and the injector valve was gradually opened to increase the flow rate to the nozzle. The corresponding pressure was recorded, and the cover was removed from the pickup for a duration of 120 s. The cover was reapplied, and the accumulated water in the reservoir was weighed. Equation 4 determined the mass flow rate, m, of the droplets through the pickup cross-section.

$$\dot{m} = \frac{{m}_{{H}_{2} O}}{Δ t} \qquad ( Eq . 4 )$$

The LWC can be calculated, per Equation 5, as density ρ (kg/m³) of the air-water mixture traversing through the cross-sectional area A of the PVC pipe, where v was the set airspeed (m/s) [21]. The process was repeated until the desired LWC was achieved.

$$\dot{m} = ρ vA \to ρ = \dot{m} = \frac{\dot{m}}{v ( π {r}^{2} )} \qquad ( Eq . 5 )$$

Test Injector Configuration. The ability to predict droplet MVD depended on the selection of the test injector, which atomized pressurized water from a hose to the desired diameter. Before selecting a spray nozzle to meet the defined MVD and LWC criteria, the study introduced a standard to classify droplet size that was provided by the American Society of Agricultural and Biological Engineers (ASABE) in ASABE S572.1 [22]. While the classification was intended for agriculture and horticulture, nozzles with distinct droplet sizes were produced in accordance with this standard, and hence were used to estimate a range of nozzles for testing. Table 3 defines classification groups of water droplets by distinct MVD ranges, which were assigned respective color codes. The adapted SAE AS5562 standard in Table 2 called for an MVD of 200-1000 μm, which eliminated extremely fine (purple) and very fine (red) nozzles.

TABLE 3

| | Size | VMD | |
|---|---|---|---|
| Spray | of | range | Color |
| quality | droplets | (μm) | code |
| Extremely fine | Small | <60 | Purple |
| Very fine | | 61-105 | Red |
| Fine Medium Coarse Very coarse Extremely coarse | [symbol] | 106-235 236-340 341-403 404-502 503-665 | Orange Yellow Blue Green White |
| Ultra course | Large | >665 | Black |

Table 4 provides insight into which classes of droplet sizes may be expected for various meteorological conditions. As testing was intended for sUAV, the light rain degree of atomization was selected as the upper bound of droplet diameter consideration. Light rain produced an MVD of approximately 500-800 μm, which broadened the limits of consideration to 200-800 μm.

TABLE 4

| Degree | Droplet | Relative size |
|---|---|---|
| of | size | related to |
| atomization | (μm) | common objects |
| Fog | Up to 25 | Needle Point (25 μm) |
| Fine Mist | 20-100 | Human Hair (100 μm) |
| Fine Drizzle | 100-250 | Sewing Thread (150 μm) |
| Heavy Drizzle | 250-500 | Toothbrush Bristle (300 μm) |
| Light Rain | 500-800 | Staple (550 μm) |
| Heavy Rain | 800-1000 | Paper Clip (850 μm) |
| Thunderstorm Rain | 1000-4000 | #2 Pencil Lead (2000 μm) |

However, atomized droplets of large diameter injected into a moving stream of air were susceptible to further atomization. Equation 6 shows the maximum diameter of a droplet injected into a flowing gas with known velocity before it splits apart [23].

$${d}_{max} = \frac{γ ( We )}{{ρ}_{air} {v}^{2}} \qquad ( Eq . 6 )$$

In Equation 6, γ=0.026 N/m is the surface tension coefficient, ρₐᵢᵣ=1.293 kg/m³ is the density of air in standard conditions, v=[14], m/s are the test velocities, and (We)=2.7 is average critical Weber number for splitting water droplets [24].

For v=14 m/s, the injector nozzle may expel droplets no more than dₘₐₓ=277 μm in diameter to avoid excessive droplet breakup. For v=30 m/s, the threshold lowers to dₘₐₓ=60 μm. The former value fell in the medium (yellow) MVD range or heavy drizzle.

A medium-course nozzle was selected to allow for upward trimming. Manual adjustment was achieved using an inline ball valve in series with a bourbon pressure gauge positioned just before the nozzle. The assembly was connected to a standard utility hose and mounted to the blower outlet, with the right-angle nozzle positioned just inside the stream.

The 14 m/s test ensured that the pitot-static tube can manage liquid water at landing speeds when clogging may be a greater risk. Therefore, MVD was critical for the 14 m/s test. The diameter dₘₐₓ=60 μm value for the 30 m/s test case fell short of the 200 μm lower bound given by Table 2. Despite the low MVD, the 30 m/s test case ensured that the probe can process a more atomized mixture (e.g., mist), which may clog the pressure outlets and brass barbs just before the transducer.

Test Procedures. The study collected data using two independent Pixhawk Cube Blue autopilots linked via serial connection to a ground station computer. Each autopilot had a GPS antenna for time syncing and an I2C mRO JST-GH pressure transducer. To collect synced logs and to monitor real-time performance, the study concurrently ran two instances of Mission Planner (MP), one for each airspeed sensor.

Testing consisted of weeping (wet) and dry control runs, each requiring an autopilot power cycle for discrete log generation. After booting each autopilot, a new log cycle would begin, and both airspeed sensors were zeroed in MP. The ten-inch water content bank of a Netscanner model 9816pressure scanner was used to calibrate the blower RPM to the correct dry airspeed. For dry runs, the target velocity was held for 60 s before the logs were terminated. Dry trials tested one custom probe (A through D) per run on the first autopilot channel. The second channel was occupied with the hobby-grade probe with the mRO JST-GH pressure transducer. The study later analyzed the performance of the two sensors.

For weeping testing, the study calibrated the LWC after blower calibration. Droplet MVD verification was followed using the measurement tool on a high-speed camera, which scaled pixel size against a known reference in the frame. The study analyzed video footage of droplets near the test unit's total pressure intakes frame-by-frame. Per the test case, ten droplets in the focus were selected for measurement to calculate the MVD. Once all test thresholds were confirmed at steady-state, a 60-s collection period was timed before the logs were terminated. Table 2 shows that the study performed weeping test cases for probes A through D. The study also performed dry control tests for each probe at 14 m/s and 30 m/s.

### Experimental Results

Dry Control Testing. The study performed eight dry tests, one per probe per velocity, to evaluate the performance of the probes under normal operating conditions relative to a generic COTS control (CTRL) alternative. FIGS. 6B-6E show the logs for each test unit vs. COTS sensor over a 60 s interval for 14 m/s and 30 m/s test velocities. Dotted dashed lines 602 and 604 represent nominal airspeeds, verified with the Netscanner probe. Table 5 shows a summary of the dry test runs and the percent error of each probe relative to the Netscanner reading.

TABLE 5

| | FDM CP/PTFE | | | | | | | |
|---|---|---|---|---|---|---|---|---|
| Probe ID | A | CTRL | A | CTRL | B | CTRL | B | CTRL |
| Vₙₒₘᵢₙₐₗ | 13.96 | | 30.02 | | 13.99 | | 29.78 | |
| (m/s) | | | | | | | | |
| V_{avg} (m/s) | 16.31 | 12.26 | 35.10 | 26.47 | 18.26 | 14.40 | 38.55 | 29.62 |
| Percent | 16.81% | 12.16% | 16.92% | 11.82% | 30.51% | 2.95% | 29.44% | 0.54% |
| Error (%) | | | | | | | | |

PLA Resin

| Probe ID | C | CTRL | C | CTRL | D | CTRL | D | CTRL |
|---|---|---|---|---|---|---|---|---|
| Vₙₒₘᵢₙₐₗ | 13.96 | | 30.02 | | 13.99 | | 29.78 | |
| (m/s) | | | | | | | | |
| V_{avg} (m/s) | 16.10 | 13.51 | 36.09 | 26.20 | 16.94 | 13.73 | 36.72 | 29.89 |
| Percent | 15.31% | 3.22% | 20.21% | 12.72% | 21.12% | 1.89% | 23.33% | 0.38% |
| Error (%) | | | | | | | | |

Because probes A and C represented the combined-barrel design, as shown in Table 1, the study analyzed them together as data group AC. The study paired probes B and D as the separated-barrel design and denoted them as the data group BD.

Dry group AC was within Δv=2 m/s of 14 m/s and Δv=6 m/s of 30 m/s, yielding a 16-20% error. Excluding probe A data, the control probe remained within Δv=1 m/s of nominal. The error may be due to a non-binding zeroing of the COTS sensor. Dry Group BD was less accurate, performing within Δv=4 m/s of 14 m/s and Δv=9 m/s of 30 m/s, yielding a 21-31% error. As with the AC group, the control probe read within Δv=1 m/s of nominal. Therefore, the combined-barrel design may be more accurate than the separated configuration in dry operating conditions.

The consistent steady-state delta velocities (Δv) facilitated the application of virtual trimming within common groups. For instance, a trim of 2 m/s may be assigned to group AC to offset the 16 m/s average reading to nominal. Trimming consequently lowered the 35-36 m/s average reading to 33-34 m/s, which may be more acceptable. For more accurate readings at higher velocities, a non-linear offset curve may be implemented along the velocity range of the aircraft to map readings against a lab-tested calibration table. The automatic offset mitigated the low-velocity bias of the sensor.

The inaccuracy of the weeping probes was expected due to large orifice sizes and volumes within the sensors. Larger cavities may be susceptible to turbulent flow, and the circulation of an air-water mixture to support drainage may impact readings. In contrast, the hobbyist control probe orifice and interior volume were optimized for dry environments but would not function in IMC conditions. The tradeoff of using a weeping probe was the necessity of trimming.

MVD Calibration Data. The study measured 10 droplets with the high-speed camera per test case for MVD verification. FIG. 6J shows the sample captures from the camera. Table 6 shows the resultant diameters for each test case, sorted for median calculation.

TABLE 6

| Droplet | R1.1 | R1.2 | R2.1 | R2.2 | R3.1 | R3.2 | R4.1 |
|---|---|---|---|---|---|---|---|
| d1 | 368.4 | 233.3 | 218.8 | 218.8 | 218.8 | 250.0 | 205.9 |
| d2 | 368.4 | 233.3 | 309.4 | 309.4 | 309.4 | 250.0 | 205.9 |
| d3 | 368.4 | 233.3 | 437.5 | 437.5 | 437.5 | 250.0 | 205.9 |
| d4 | 411.9 | 233.3 | 437.5 | 437.5 | 437.5 | 250.0 | 205.9 |
| d5 | 552.6 | 233.3 | 437.5 | 437.5 | 437.5 | 250.0 | 205.9 |
| d6 | 552.6 | 330.0 | 437.5 | 437.5 | 437.5 | 500.0 | 411.8 |
| d7 | 552.6 | 330.0 | 437.5 | 437.5 | 538.5 | 500.0 | 411.8 |
| d8 | 552.6 | 330.0 | 538.5 | 437.5 | 538.5 | 500.0 | 411.8 |
| d9 | 736.8 | 466.7 | 538.5 | 538.5 | 538.5 | 559.0 | 617.6 |
| d10 | 759.5 | 466.7 | 656.3 | 538.5 | 656.3 | 790.6 | 651.1 |
| MVD | 552.6 | 281.7 | 437.5 | 437.5 | 437.5 | 375.0 | 308.9 |
| (μm) | | | | | | | |

For each test case, Table 6 shows that the MVD was greater than the 200 μm threshold outlined in Table 2. The average MVD was 450.5 μm for the 14 m/s runs and 303.5 μm for the 30 m/s runs.

Therefore, the predicted levels of atomization were not met in the testing environment. On-site, the study found limited mounting options for the injector assembly on the blower, and the droplets were injected straight at the test stand instead of perpendicular to the flow. The latter configuration would inject the droplets into the stream with near-zero horizontal velocity, atomizing the droplets during acceleration with values more aligned with the estimate. Injecting the droplets in line with the airstream resulted in elevated but acceptable MVDs.

Weeping Probe Testing. As shown in Table 2, the study performed twelve weeping tests, with the log results given by FIGS. 6F-6I. As with the dry testing, the dotted dashed lines 606 and 608 represented nominal airspeeds that were verified with the Netscanner. Table 7 summarizes the weeping test runs and the percent error of each probe. The V_{avg} and percent error for B under R2.1 represent a logging error and are omitted from the analysis and FIG. 6G.

TABLE 7

| | R set | | | | | | | |
|---|---|---|---|---|---|---|---|---|
| | R1.1 | | R1.2 | | R2.1 | | R2.2 | |
| | Probe ID | | | | | | | |
| | A | B | A | B | A | B | A | B |
| Vₙₒₘᵢₙₐₗ (m/s) | 14 | | 30 | | 14 | | 30 | |
| V_{avg} (m/s) | 8.04 | 12.88 | 29.43 | 37.12 | 7.64 | 4.89 | 29.29 | 37.40 |
| Percent Error | 42.58% | 7.99% | 1.90% | 23.72% | 45.42% | 65.04% | 2.38% | 24.68% |
| (%) | | | | | | | | |
| | R set | | | | | | | |
| | R3.1 | | R3.2 | | R4.1 | | R4.2 | |
| | Probe ID | | | | | | | |
| | A | B | A | B | C | D | C | D |
| Vₙₒₘᵢₙₐₗ (m/s) | 14 | | 30 | | 14 | | 30 | |
| V_{avg} (m/s) | 6.66 | 13.26 | 28.64 | 37.73 | 9.95 | 13.94 | 30.69 | 35.25 |
| Percent Error | 52.41% | 5.30% | 4.54% | 25.77% | 28.92% | 0.45% | 2.30% | 17.51% |
| (%) | | | | | | | | |
| | R set | | | | | | | |
| | R5.1 | | R5.2 | | R6.1 | | R6.2 | |
| | Probe ID | | | | | | | |
| | C | D | C | D | C | D | C | D |
| Vₙₒₘᵢₙₐₗ (m/s) | 14 | | 30 | | 14 | | 30 | |
| V_{avg} (m/s) | 9.94 | 14.25 | 31.20 | 35.95 | 8.10 | 14.01 | 29.55 | 35.36 |
| Percent Error | 29.02% | 1.80% | 3.99% | 19.84% | 42.14% | 0.08% | 1.51% | 17.88% |
| (%) | | | | | | | | |

Weeping group AC performed within Δv=7.0 m/s of 14 m/s and Δv=1.5 m/s of 30 m/s, yielding error ranges of 42.6-52.4% and 1.9-4.5%, respectively. The accuracy of the weeping group AC was greater at the upper test velocity, so positive low-end trimming may be required. For example, a non-linear offset table may set 30 m/s as the datum and scale data approaching zero with an increasing weight to shift the points in the positive direction. The scaling operation would narrow the 7.0 m/s delta to within a 1-2 m/s band about the 14 m/s test velocity.

AC and BD dry groups required negative low and high-end trimming to compensate for overshooting relative to each test velocity. Weeping test group BC shared the paradigm of negative scaling, though only for upper velocity ranges, so both groups may be aligned in the type of trim applied. This relationship had further benefits, as the dry and weeping BC airspeeds read in the 35.0-38.5 m/s range. Therefore, the upper velocities for the dry and weeping BD conditions may be scaled similarly. Additionally, the weeping group BD was most accurate at landing speeds, which can be employed for safety and asset protection.

The study classified sensor clogs as dips of 3 m/s or more from average in the velocity profile for at least 1.5 s in duration, or any 6 m/s or greater dip from average for at least 0.5 s. The study considered troughs not exceeding 0.5 s as outlier noise. The weeping BD group was less prone to blockage than the AC group, with the latter indicating approximately four total moderate blockage events. The BD reported approximately one to two minor blockages. For both groups, clogs occurred during 14 m/s testing and occurred more often at higher LWCs. The elevated degree of droplet atomization improved water processing efficiency at the higher 30 m/s test velocity. The tradeoff for increased wicking efficiency at higher velocities was a noisier or wider steady-state band. However, while a wider band may present more hindrance for real-time airspeed monitoring, the average velocity remained consistent and predictable.

Final Probe Selection. The study narrowed the selection to group BD, representing the FDM and SLA prints of the separated barrel configuration for the exemplary apparatus. Therefore, the evaluation was focused on material characteristics and performance.

Overall, probe D outperformed probe B in dry and wet environments, as the logs showed that the former reported airspeeds closer to nominal. The precision of probe D in low airspeed testing was significant, with the average error relative to nominal equating to 0.78%. For comparison, the error of probe B under the same conditions averaged 16.3%. Thus, asset D was a reliable datum for high-velocity trim procedures and, by default, provided reliable airspeeds during landing.

The improved performance of the resin print comes with a 79% increase in mass relative to the PC/PTFE equivalent. Extra mass is detrimental to sUAV, which prioritized weight reduction to maximize flight time. At approximately $0.14/g [25], the separated barrel resin probe costs around $5.02 to print per unit, while the PC/PTFE is half the cost at $2.59. The resin printed in 34 hours, though this was at highly detailed 100 μm resolution—and required added time for post-curing, burr removal, and sanding. The PC/PTFE was difficult to initiate, but proceeded smoothly once a functional print methodology was established. The FDM pair was printed in 24 hours at 200 μm resolution and required some post-processing. All else equal, accounting for material and labor costs and machine availability, the FDM prints were more cost-effective and conducive to rapid fabrication than the SLA resin variant.

PC/PTFE was observed in the study to be better suited to absorb shock from crash-induced loading than the more brittle SLA resin, which improved sensor reusability. Otherwise, the two materials were evenly matched in mean time between failure (MTFB) considerations, and neither showed indication of leaks, moisture absorption, or other mechanical faults during testing. The study concluded that both material options were acceptable for fielding on sUAV in IMC. Specific use cases and fabrication constraints, such as printer availability and expected build quantity, should be considered by the end user for final material determination.

### Discussion

Pertinent test parameters were adapted for sUAV application from SAE standard AS5562, which outlines wet airspeed sensor testing for manned aircraft. An injector system was devised to replicate liquid precipitation of a defined MVD range and a set of three LWC densities. ASABE standard S572.1 was employed to begin the search for an injector nozzle. The final nozzle was selected by predicting the maximum possible diameter of droplets in a freestream before further atomization can occur. Test procedures were devised to calibrate LWC and to measure MVD using a high-speed camera.

Control testing relative to a COTS airspeed sensor provided insight into the performance of the weeping sensors in dry conditions at 14 m/s and 30 m/s test velocities. The study concluded that the sensors, which were not optimized for dry conditions, may require trimming in software to shift readings towards nominal airspeeds. The same was concluded for weeping tests, where the combined-barrel design reached peak accuracy at 30 m/s. Inversely, the accuracy of the separated-barrel design peaked at 14 m/s. The separated-barrel resin print reported superior accuracy at landing speeds and aligned closely with its dry performance, simplifying trimming operations. The study reported and compared MVD data from the high-speed camera to the calculated estimates.

Additionally, while a resin print of the separated-barrel design may be accurate, a PC/FTFE print may be affordable and compatible for mass fabrication.

The source of error in this study pertained to the injector system, which proved difficult to calibrate to the desired LWC. The output of the nozzle limited the ability to predict LWC based on pressure gauge readings. Another source of error was the MVD data collection with the high-speed camera, which had difficulty measuring droplets below 300 μm in diameter.

Further investigation may determine if a single master trim profile, or airspeed ratio calibration, may manage offsets for both dry and wet conditions, or if two profiles should be made and switched manually during pre-flight.

Additional optimization and simulation of the sensor geometry may act to mitigate the need for software trim. The observed positive velocity discrepancy at higher altitudes indicated an elevated static pressure. Future testing could compare static readings from a separate instrument in a dry environment to a wet test subject to isolate and quantify the error.

### Conclusion

Computer-executable instructions, such as program modules, being executed by a computer may be used. Generally, program modules include routines, programs, objects, components, data structures, etc., that perform particular tasks or implement particular abstract data types. In its most basic configuration, the controller includes at least one processing unit and memory. Depending on the exact configuration and type of computing device, memory may be volatile (such as random-access memory (RAM)), non-volatile (such as read-only memory (ROM), flash memory, etc.), or some combination of the two. The controller may have additional features/functionality.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited but rather may be implemented in connection with any computing environment, such as a network or distributed computing environment. Still further, aspects of the presently disclosed subject matter may be implemented in or across a plurality of processing chips or devices, and storage may similarly be implemented across a plurality of devices. Such devices might include personal computers, network servers, handheld devices, and wearable devices, for example.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications, and publications, as listed below and throughout this document, are hereby incorporated by reference in their entirety herein.
[1] “Assessing the Risks of Integrating Unmanned Aircraft Systems (UAS) into the National Airspace System.” National Academies of Sciences, Engineering, and Medicine, 2018. https://doi.org/10.17226/25143.
[2] Bird, John J., Camron A. Hirst, Steven Valenzuela, Steve Borenstein, and Eric W. Frew. “An Autopilot Interface to Advance Fixed-Wing UAS Autonomy Research.” AIAA SCITECH 2022 Forum, 2022. https://doi.org/10.2514/6.2022-1852.
[3] Golly, Timothy T, and Jason Debo. System and method for detecting blocked pitot-static ports, issued May 17, 2012.
[4] Sklenář, Filip, and Jiří Matějů. “Indicated Airspeed Error Due to Gradual Blocking of Pitot Tube with Drain Hole.” Aviation 26, no. 1 (2022): 64-71. https://doi.org/10.3846/aviation.2022.15963.
[5] Jackson, David A. “Concept of a Pitot Tube Able to Detect Blockage by Ice, Volcanic Ash, Sand and Insects, and to Clear the Tube.” Photonic Sensors 5, no. 4 (September 11, 2015): 298-303. https://doi.org/10.1007/s13320-015-0272-x.
[6] Potter, Merle C., D. C. Wiggert, Bassem Ramadan, and Tom I-P. Shih. “Chapter 3: Introduction to Fluids in Motion.” Essay. In Mechanics of Fluids, 5th ed., 102-12. Boston, MA: Cengage Learning, 2015.
[7] Brown, Tom. “How to Avoid Pitot-Static System Problems.” Plane and Pilot 35, no. 4, April 1999. https://www.proquest.com/docview/233506071/fulltext/5B249B3919154607PQ/1?accounti d=111 07.
[8] Boldmethod. “What Happens When Your Pitot Tube Ices Over?” Boldmethod, November 24, 2022. https://www.boldmethod.com/learn-to-fly/systems/what-happens-when-your-pitot-tube-ices-over-airspeed-indicator-failure/#:˜:text=The%20pitot%20tube%20also%2 0has,your%20fuselage%20measure%20static%20 pressure.
[9] “Surface Tension.” Elements of Physics I. Accessed June 21, 2023. http://labman.phys.utk.edu/phys221core/module s/m7/surface_tension.html#:˜:text=The%20force%20do%20to%20the,law%20for%20a%20spherica 1% 20membrane.
[10] çengel, Yunus A., John M. Cimbala, and Robert H. Turner. “Chapter 10: Introduction and Properties of Fluids.” Essay. In Fundamentals of Thermal-Fluid Sciences, 5th ed., 430-36. New York, NY: McGraw-Hill Education, 2017.
[11] Yang, Huadong, Fengchao Ji, Zhen Li, and Shuai Tao. “Preparation of Hydrophobic Surface on PLA and ABS by Fused Deposition Modeling.” Polymers 12, no. 7 (July 12, 2020): 1539. https://doi.org/10.3390/polym12071539.
[12] Lovinčić Milovanović, Vedrana, Cédric Guyon, Ivana Grčić, Michael Tatoulian, and Domagoj Vrsaljko. “Modification of Surface Hydrophobicity of PLA/PE and ABS/PE Polymer Blends by ICP Etching and CFX Coating.” Materials (Basel) 13, no. 23 (December 13, 2020): 1-14. https://doi.org/10.3390/ma13235578.
[13] Barbosa, Ana Isabel, Augusto Sampaio Barreto, and Nuno Miguel Reis. “Transparent, Hydrophobic Fluorinated Ethylene Propylene Offers Rapid, Robust, and Irreversible Passive Adsorption of Diagnostic Antibodies for Sensitive Optical Biosensing.” ACS Applied Bio Materials 2, no. 7 (May 22, 2019): 2780-90. https://doi.org/10.1021/acsabm.9b00214.
[14] Paz-Gómez, Guillermo, Juan Carlos del Caño-Ochoa, Oscar Rodríguez-Alabanda, Pablo Romero, Miguel Cabrerizo-Vílchez, Guillermo Guerrero-Vaca, and Miguel Rodríguez-Valverde. “Water-Repellent Fluoropolymer-Based Coatings.” Coatings 9, no. 5 (April 28, 2019): 1-13. https://doi.org/10.3390/coatings9050293.
[15] Shamsuddin, Muhamad Syukri, Ainur Hanim Othman, Ramdziah Md Nasir, Aziz Hassan, Rozaimi Senawi, Mohd Zharif Thirmizir, and Zainal Arifin Ishak. “Influence of PTFE as a Solid Lubricant on the Mechanical, Electrical, and Tribological Properties of CF-Reinforced PC Composites.” Journal of Applied Polymer Science 138, no. 18 (December 7, 2020). https://doi.org/10.1002/app.50346.
[16] “PC/PTFE—Spectrum Filaments.” Spectrum Filaments, October 26, 2022. https://spectrumfilaments.com/en/filament/pc-ptfe/.
[17] Griffey, Jason. “Chapter 2: The Types of 3-D Printing.” Library Technology Reports 50, no. 5 (July 2014). https://www.journals.ala.org/index.php/ltr/articl e/view/4796/5747https://www.
[18] Loth, Nick. “Polypropylene (PP) 3D Printing—the Ultimate Guide.” All3DP Pro, March 22, 2023. https://all3dp.com/1/polypropylene-3d-printing-pp-ultimate-guide/.
[19] Dwamena, Michael. “Can Resin Prints Melt? Are They Heat Resistant?” 3D Printerly, 2023. https://3dprinterly.com/can-resin-prints-melt-are-they-heat-resistant/.
[20] “AS5562: Ice and Rain Minimum Qualification Standards for Pitot and Pitot-Static Probes.” SAE Standards, Feb. 11, 2020, 1-17. https://doi.org/10.4271/as5562.
[21] Knop, Inken, Stephan E. Bansmer, Valerian Hahn, and Christiane Voigt. “Comparison of Different Droplet Measurement Techniques in the Braunschweig Icing Wind Tunnel.” Atmospheric Measurement Techniques 14, no. 2 (March 3, 2021): 1761-81. https://doi.org/10.5194/amt-14-1761-2021.
[22] “ASABE S572.1 Droplet Size Classification.” HubSpot. Accessed June 21, 2023. https://cdn2.hubspot.net/hub/95784/file-32015844-pdf/docs/asabe_s572.1_droplet_size_classification.pdf.
[23] Petela, Ryszard, and Antoni Zajdel. “Calculation of a Mean Droplet Diameter of an Atomized Mixture of Dust and Liquid.” Fuel: the Science and Technology of Fuel and Energy 59, no. 11 (November 1980): 795-98. https://doi.org/10.1016/0016-2361(80)90258-6.
[24] Luna, R E, and W A Klikoff. Rep. AERODYNAMIC BREAKUP OF LIQUID DROPS. Albuquerque, NM: USDOE, 1967. https://doi.org/10.2172/4318080.
[25] Moceri, Mike. “How to Accurately Price for Stereolithography (SLA) 3D Printing Projects.” 3D Printing Industry, May 26, 2020. https://3dprintingindustry.com/news/how-to-accurately-price-for-stereolithography-sla-3d-printing-projects-171977/.
[26] U.S. Pat. No. 9,366,555-B2
[27] US Publication No. 20150177032-A1

What is claimed:

1. An apparatus for determining an airspeed of a UAV, the apparatus comprising:
a sensor housing;
an ingress, formed at a first end of the sensor housing, configured to receive a first airflow for a total pressure measurement;
one or more circulation chambers, including a first circulation chamber, operatively coupled to the ingress through an elongated tube, wherein the first circulation chamber defines a first volume for retaining the first airflow and separating moisture from the first airflow, the first circulation chamber comprising:
a first surface, defined in the first volume, with which the first airflow contacts to circulate in the first volume;
at least one drainage port, including a first drainage port, extending from the first volume, wherein the first drainage port is configured to expel liquid of the separated moisture from the first airflow; and
a first sampling port extending into the one or more circulation chambers and configured to direct a portion of the first airflow to a sensor located in the sensor housing, wherein the sensor is configured to provide a total pressure measurement using the first airflow,
wherein the total pressure measurement is used, at a controller, in part, to compute an airspeed of the apparatus.

2. The apparatus of claim 1, further comprising
a second circulation chamber, operatively coupled to the first circulation chamber via an inclined tube, defining a second volume for receiving airflow from the first circulation chamber and separating moisture from said received airflow, the second circulation chamber comprising:
a second surface, defined in the second volume, with which the received airflow at the second circulation chamber contacts to circulate in the second volume; and
at least one drainage port, including a second drainage port, extending from the second volume, the second drainage port configured to expel liquid from the first airflow in the second volume,
wherein the first sampling port extends into the second circulation chamber.

3. The apparatus of claim 2, further comprising:
a static pressure chamber having at least one static pressure ingress configured to receive a second airflow, wherein the static pressure chamber defines a third volume for retaining and separating moisture from the second airflow, the static pressure chamber comprising:
at least one drainage port, including a third drainage port, extending from the third volume, the third drainage port configured to expel liquid from the second airflow in the third volume; and
a second sampling port formed of an extended structure protruding into the static pressure chamber and configured to direct the second airflow to the sensor for a static pressure measurement, wherein the static pressure measurement is combined with the total pressure measurement, at the controller, to compute the airspeed of the apparatus.

4. The apparatus of claim 1, further comprising:
a tube sampling port, formed on the elongated tube, wherein the tube sampling port has at least one static pressure ingress configured to receive a second airflow; and
a static pressure chamber fluidically coupled to the tube sampling port, defining a third volume for retaining and separating moisture from the second airflow, the static pressure chamber comprising:
at least one drainage port, including a third drainage port, extending from the third volume, the third drainage port configured to expel liquid from the second airflow in the third volume; and
a second sampling port formed of an extended structure protruding into the static pressure chamber and configured to direct the second airflow to the sensor for a static pressure measurement, wherein the static pressure measurement is combined with the total pressure measurement, at the controller, to compute the airspeed of the apparatus.

5. The apparatus of claim 1, wherein each of the one or more circulation chambers includes a surface, including the first surface, with which the airflow contacts to (i) cause circulation in the respective circulation chamber and (ii) separate moisture from the airflow, wherein said surface of the respective circulation chamber is a water-resistant surface.

6. The apparatus of claim 1, wherein the first drainage port is horizontally extending from the first volume.

7. The apparatus of claim 2, wherein the second drainage port is extending from the second volume at a rear end of the second circulation chamber.

8. The apparatus of claim 1, wherein the first sampling port is vertically extending from a volume of the one or more circulation chambers.

9. The apparatus of claim 1, wherein the sensor is a pressure transducer or a pressure insole.

10. The apparatus of claim 2, wherein the first sampling port is vertically extending from the second volume of the second circulation chamber.

11. The apparatus of claim 3, wherein the second sampling port is vertically extending from the third volume of the static pressure chamber.

12. The apparatus of claim 3, wherein the second circulation chamber is located at a second end of the sensor housing.

13. The apparatus of claim 12, wherein the static pressure chamber is located at the second end of the sensor housing, beneath the second circulation chamber.

14. The apparatus of claim 1 is configured for both wet and dry conditions for the UAV.

15. An airspeed sensor apparatus comprising:
a sensor housing;
an ingress, formed at a first end of the sensor housing, configured to receive a first airflow for a total pressure measurement;
one or more circulation chambers, including a first circulation chamber and a second circulation chamber, operatively coupled to the ingress through an elongated tube, wherein the first circulation chamber defines a first volume for retaining the first airflow and separating moisture from the first airflow, and the second circulation chamber defines a second volume for receiving airflow from the first circulation chamber and separating moisture from said received airflow, the first circulation chamber comprising (i) a first surface, defined in the first volume, with which the first airflow contacts to circulate in the first volume and (ii) at least one drainage port, including a first drainage port, extending from the first volume, wherein the first drainage port is configured to expel liquid of the separated moisture from the first airflow; and
a first sampling port extending into the one or more circulation chambers and configured to direct a portion of the first airflow to a sensor region located in the sensor housing,
a static pressure chamber having at least one static pressure ingress configured to receive a second airflow, wherein the static pressure chamber defines a third volume for retaining and separating moisture from the second airflow, the static pressure chamber comprising at least one drainage port, including a third drainage port, extending from the third volume, the third drainage port configured to expel liquid from the second airflow in the third volume; and
a second sampling port formed of an extended structure protruding into the static pressure chamber and configured to direct the second airflow to the sensor region for a static pressure measurement,
a pressure sensor located in the sensor region and configured to measure the total pressure measurement using the first airflow and measure the static pressure measurement using the second airflow, wherein the total pressure measurement and static pressure measurement are combined to compute the airspeed of the apparatus.

16. The apparatus of claim 15, further comprising:
a tube sampling port, formed on the elongated tube, wherein the tube sampling port has at least one static pressure ingress configured to receive the second airflow and direct to the static pressure chamber.

17. The apparatus of claim 15, wherein the sensor is a pressure transducer or a pressure insole.

18. The apparatus of claim 15, wherein the first sampling port is vertically extending from the second volume of the second circulation chamber.

19. The apparatus of claim 15, wherein the second sampling port is vertically extending from the third volume of the static pressure chamber.

20. An UAV comprising:
a sensor or UAV housing;
an ingress, formed at a first end of the sensor or UAV housing, configured to receive a first airflow for a total pressure measurement;
one or more circulation chambers, including a first circulation chamber, operatively coupled to the ingress through an elongated tube, wherein the first circulation chamber defines a first volume for retaining the first airflow, the first circulation chamber comprising:
a first surface, defined in the first volume, with which the first airflow contacts to circulate in the first volume;
at least one drainage port, including a first drainage port, extending from the first volume, wherein the first drainage port is configured to expel liquid from the first airflow; and
a first sampling port, operatively coupled to the one or more circulation chambers, configured to lead the first airflow to a sensor located at a second end of the housing, wherein the sensor is configured to provide a total pressure measurement using the first airflow,
wherein the total pressure measurement is used, at a controller, to compute an airspeed measurement of the UAV.
